(19) United States
(12) Patent Application Publication
(10) Pub. No.: US 2002/0128791 A1
(43) Pub. Date: Sep. 12, 2002

(54) Integrated circuit of an electronic thermometer

(76) Inventors: Min-Yung Chen, Taipei City (TW); Chih-Wei Hsieh, Taipei City (TW)

Correspondence Address: Min-Yung CHEN, PO Box 82-144, Taipei, TW

(21) Appl. No.: 09/800,658

(22) Filed: Mar. 8, 2001

(51) Int. Cl. G01K 15/00

(52) U.S. Cl. 702/99; 702/130

(57) ABSTRACT

An Integrated Circuit (IC) of an electronic thermometer includes resistors and capacitors combination, logic switch system or formulated compensation parameter table being established therein for calibration of preset objective value of software and hardware utilized by the system to select optimum compensated resistors and capacitors arranged combination or the optimum parameter group within the compensation parameter table, the selected combination being written into the internal established or externally mounted EEPROM or Memory such that the internally established programs in the IC accesses the resistors and capacitors combination or the compensated parameters.

### BACKGROUND OF THE INVENTION

1. Field of the Invention

The present invention relates to an Integrated Circuit of an electronic thermometer, and in particular, an IC employing selected resistors and capacitors combinations so as to provide a simple manufacturing process.

2. Description of the Prior Art

In the manufacturing process of conventional thermometer, the thermo-sensitive resistor and the center resistor are classified into different categories based on their impedance value. The accuracy of the thermometer by this method has an error of 600Ω (about 0.6° C., and the accuracy requirements all over the world being ±0.1° C.). As a result, in the course of measuring, inaccuracy is common found, and due to wide scope of categories of thermometers, these inaccuracies cause an accumulation of thermometers of various categories being produced and thus the cost of production is high.

Accordingly, it is a prime object of the present invention to provide an Integrated Circuit of an electronic thermometer, which can mitigate the above-mentioned drawbacks.

### SUMMARY OF THE INVENTION

Accordingly, it is an object of the present invention to provide an Integrated Circuit (IC) of an electronic thermometer comprising a formulated compensation parameter table or a system of logic switches, and a combination of resistors and capacitors being established therein for calibration of preset objective value of software and hardware utilized by the system to select the optimum compensated resistors and capacitors arrangement or the optimum reference group within the reference compensation table, the selected combination being written into the internal established or externally mounted EEPROM or Memory such that the internally established programs in the IC access the resistors and capacitors combination or the compensated parameters.

Yet another object of the present invention is to provide an integrated circuit of an electronic thermometer wherein the resistors and capacitors combination or formulated compensation parameters are accessed by utilizing the objective value of the software and hardware via the method of connection in series or in parallel to select the optimum compensated resistors and capacitors combination and by increasing the voltage and current to melt off the circuit in order to maintain the selected compensated resistors and capacitors combination or parameters combinations.

A further object of the present invention is to provide an Integrated Circuit of an electronic thermometer wherein the IC circuit comprises a logic circuit for switching between Celsius degree C. and Fahrenheit degree F. and the stored memorized values are renewed or set to zero after switching, and by a sound or character displaying to show the result of switching.

Another object of the present invention is to provide an Integrated Circuit of an electronic thermometer, wherein the thermometer screen (LCD) will display “OK” or “GO” so as to clearly indicate the test result and to avoid error in the measurement.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts. Many other advantages and features of the present invention will become manifest to those versed in the art upon making reference to the detailed description and the accompanying sheets of drawings in which a preferred structural embodiment incorporating the principle of the present invention is shown by way of illustrative example.

### BRIEF DESCRIPTION OF THE DRAWINGS

FIG. 1 is a schematic view showing the manufacturing process of the present invention.

FIG. 2 is a schematic view of the calibration system of the present invention.

FIG. 3 is a schematic view showing another preferred embodiment of manufacturing process of the present invention.

FIGS. 4 and 5 show implementation flow charts of the present invention.

### DETAILED DESCRIPTION OF THE PRESENT INVENTION

For the purpose of promoting an understanding of the principles of the invention, reference will now be made to the embodiment illustrated in the drawings. Specific language will be used to describe same. It will, nevertheless, be understood that no limitation of the scope of the invention is thereby intended, such alterations and further modifications in the illustrated device, and such further applications of the principles of the invention as illustrated herein being contemplated as would normally occur to one skilled in the art to which the invention relates.

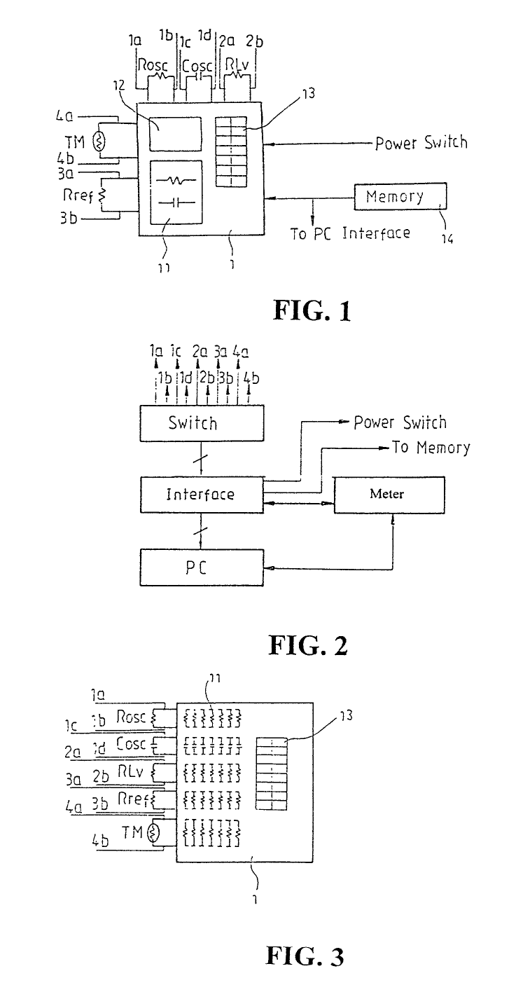

Referring to FIGS. 1 and 2, there is shown IC 1 of the electronic thermometer having internally established resistors and capacitors combination and logic switch control system 12, or formulated compensation parameters table 13, wherein, C_{OSC}, R_{OSC} of IC 1 are capacitors of the determination system oscillation frequency, R_{LV} is a resistor for determination insufficient power, TM is the thermo-sensitive resistor, Rref is the center resistor. Except for TM, other basic resistors and capacitors, Cosc, Rosc, Rw, Rref can be internally established or externally connected to IC 1.

The process of manufacturing the thermometer makes use of the calibration system of FIG. 2 and employs the preset objective values of hardware and software to select the most appropriate compensation resistor and capacitor arranged combination 11, or the most optimum parameter combination among the compensation parameter table 13, and the obtained combinations are written internally or added externally to the EEPROM (or memory) 14, such that the programs of IC 1 access the resistors and capacitors combinations or the compensated parameter combinations within the EEPROM, and after the algorithms process, the preset objective value can be obtained.

Referring to FIGS. 2 and 3, in the process of manufacturing, the resistors and capacitors combinations or formulated compensation parameters are accessed by utilizing the objective value of the software and hardware via the method of connection in series or in parallel to select the optimum compensated resistors and capacitors combinations and by increasing the voltage and current to melt off the circuit in order to maintain the selected compensated resistors and capacitors combinations or parameters combination.

In view of FIG. 1 or FIG. 3, the temperature estimation formula established internally in the IC 1 selects a specific temperature (for instance 37° C., water temperature), and the impedance value is a thermo-sensitive resistor of a fix value (for instance 30kΩ), the error at the center resistor of the thermo- sensitive resistor is 1% being allowable (for instance the center resistor at 37° C. being 29.7K to 30.3K). Based on the non-linearity characteristic of the thermo-sensitive resistor, the thermo-sensitive resistor of different center resistor value, their impedance and temperature relationships are not the same and this causes errors in measurement. In particular, when the voltage is low. Thus, in accordance with the present invention, the access to appropriate resistor combinations or parameters combination from the preset value of the calibration system can compensate the error caused by different impedance and temperature relationship, so that the measured temperature is accurate. In mass production, the oscillation frequency of the system can be easily adjusted to the objective value so that the oscillation frequency of the thermo-sensitive resistor and its feedback circuit, and the in combination center resistor of the temperature sensitive resistor and the feedback circuit approach to a consistency.

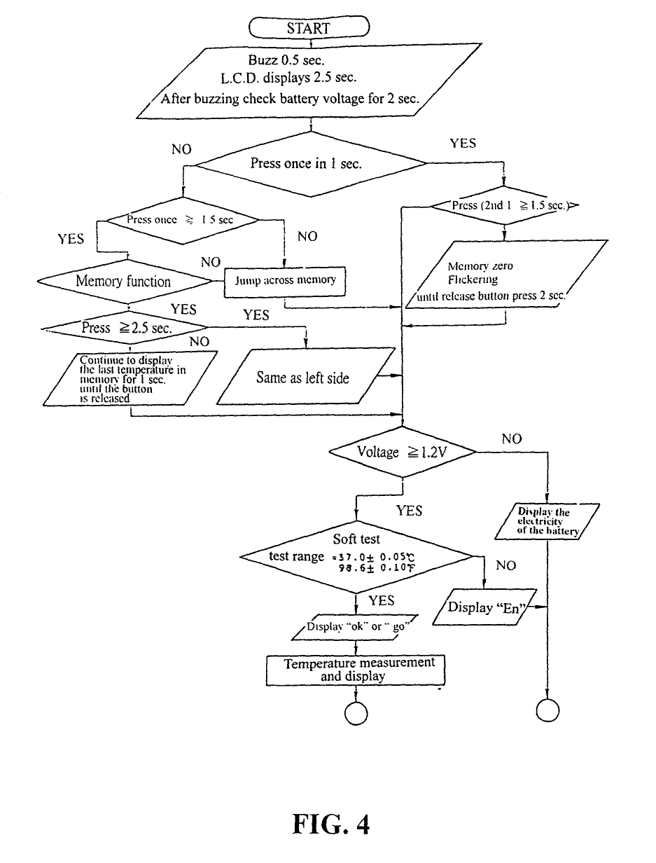

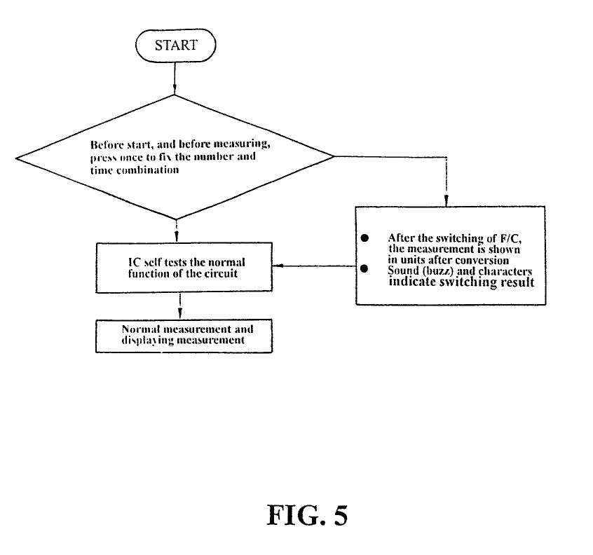

Referring to FIGS. 4 and 5, the Integrated Circuit of the present invention contains logic circuit function and single button switching function. In accordance with the present invention, “OK” characters are provided to the LCD or “GO” characters are displayed so that the user can understand the test result so as to avoid the confusion with the normal measured value.

Referring to FIG. 5, there is shown the internal of IC being incorporated with logic determination circuit. Before the measurement is shown, and the switch button is pressed for a number of time or a certain period of time, a switch between C° and F° is obtained and the result of switching is indicated by a sound and character displaying as unit. For instance, after one second the thermometer is switched on, and the switch button is pressed once for more than 1.5 second, there is a switch function between F° and C°. After the switching, the memorized value becomes zero and a buzzing sound is produced. When it is changed to C, LCD indicates a flickering C and when it changes to ° F., LCD indicates a flickering F until the button is released for more than 2 seconds.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only by the scope of the appended claims.

I claim:

1. An Integrated Circuit (IC) of an electronic thermometer comprising resistors and capacitors combination, logic switch system or formulated compensation parameter table being established therein for calibration of preset objective value of software and hardware utilized by the system to select optimum compensated resistors and capacitors arranged combination or the optimum parameter group within the compensation parameter table, the selected combination being written into the internal established or externally mounted EEPROM or Memory such that the internally established programs in the IC accesses the resistors and capacitors combination or the compensated parameters.

2. An Integrated Circuit (IC) of an electronic thermometer as set forth in claim 1, wherein the resistors and capacitors combination or formulated compensation parameters are accessed by utilizing the objective value of the software and hardware via the method of connection in series or in parallel to select the optimum compensated resistors and capacitors combination and by the method of increasing the voltage and current to melt off the circuit in order to maintain the selected compensated resistors and capacitors combination or the parameters combination.

3. An Integrated Circuit (IC) of an electronic thermometer as set forth in claim 1, wherein the IC circuit comprises a logic circuit for switching between Celsius degree C. and Fahrenheit degree F. and the stored memorized values are renewed or set to zero after switching, and by a sound or character displaying to show the result of switching.

4. An Integrated Circuit (IC) of an electronic thermometer as set forth in claim 1, wherein the IC comprises a self-test circuit, a specific characters being displayed on the thermometer screen of the test result so as to avoid the confusion of a normal temperature and an abnormal temperature.
